(19) United States
(12) Patent Application Publication
(10) Pub. No.: US 2021/0213637 A1
(43) Pub. Date: Jul. 15, 2021

(54) BEVEL STUD PUNCH

(71) Applicant: Ryan Douglas Carr-Rouse, Wainfleet (CA)

(72) Inventor: Ryan Douglas Carr-Rouse, Wainfleet (CA)

(21) Appl. No.: 16/738,063

(22) Filed: Jan. 9, 2020

(51) Int. Cl. B26F 1/14; B21D 28/26; B21D 28/02; B26F 1/36

(52) U.S. Cl. CPC B26F 1/14; B21D 28/26; B26F 2001/365; B26F 1/36; B21D 28/02

(57) ABSTRACT

A bevel stud punch attachment comprising a cylindrical head with an inner lip coupled to a punch to puncture a hole through a preselected material when a force is applied to drive the punch to penetrate the cylindrical head with the inner lip and the hole having a concave rim around an outer edge of the hole created by the inner lip. A method of using the bevel stud punch attachment to puncture a hole with a concave rim, comprising positioning the preselected material between the cylindrical head with the inner lip and the punch and applying a force to drive the punch through the preselected material and into the cylindrical head with the inner lip.

### FIELD OF THE INVENTION

The present disclosure relates to a tool for puncturing holes with a resulting concave rim, more specifically but not by way of limitation, a tool that utilizes a cylindrical head with an inner lip to deform a surrounding portion of the punctured material which can be employed to run cables, wires and pipes through.

### BACKGROUND

Current handheld metal stud punch devices employed for puncturing holes into metal studs perform their function adequately. However, for instances in which the purpose for puncturing a hole into the metal stud involves running cables or pipes through the hole, a clean cut can act to hinder feeding and retrieving the cables and pipes. There currently exist additional components, such as plastic bushings, that can be equipped to the punctured hole which act to aid in running cables and pipes. For a project that requires a plurality of puncture holes, this solution can greatly increase cost and extend time for the project.

U.S. Pat. No. 263,110 A (Buettner) discloses an improvement to a hand-held punch used in lacing-stud sets or hole punching for boots and shoes. Shortcomings include its physical inability to be employed with metal studs.

U.S. Pat. No. 9,205,520 B2 (Cooke) discloses a two-stage punch in a fastener press for installing a nut into a sheet of host material. Shortcomings include its physical inability to be employed with metal studs.

U.S. Pat, No. 3,044,531 A (Wilson) discloses a handheld tubing flaring tool where the circumference of the deformation is adjustable for various sizes of tubing. Shortcomings include its inability to be employed with an operational metal stud.

All references cited above are incorporated herein.

The devices above lack applicability with regard to puncturing a smooth, concave opening into metal studs for running cables and pipes. There exists the need for a device that creates a smooth hole with a concave feature inward which allows for easy pulling of electrical, optical and data cables and plumbing pipes through metal studs while reducing manpower, time and the force against the metal studs.

### BRIEF SUMMARY

It is the object of the present invention to provide a bevel stud punch tool.

In accordance with an aspect of the invention, there is provided a bevel stud punch attachment comprising a cylindrical head with an inner lip coupled to a punch to puncture a hole through a preselected material when a force is applied to drive the punch to penetrate the cylindrical head with the inner lip and the hole having a concave rim around an outer edge of the hole created by the inner lip.

Another aspect of the present invention is a method of using the bevel stud punch attachment to puncture a hole with a concave rim, comprising positioning the preselected material between the cylindrical head with the inner lip and the punch and applying a force to drive the punch through the preselected material and into the cylindrical head with the inner lip.

Another aspect of the present invention is a bevel stud punch comprising a stud punch having a frame comprising a body and a head, the head having first and second portions being separated from each other by a space for receiving a preselected material to be punched, a cylindrical head with an inner lip operatively associated with the first portion, a punch operatively associated with the second portion and the body supporting the first portion and the second portion wherein a hole is punctured through the preselected material when a force is applied to the first or second portions and the hole having a concave rim around an outer edge of the hole created by the inner lip.

In accordance with an embodiment of the invention, the cylindrical head with the inner lip is attached to an existing stud punch.

In accordance with an embodiment of the invention, the cylindrical head with the inner lip is fused to an existing stud punch.

In accordance with an embodiment of the invention, the preselected material is a metal stud.

In accordance with an embodiment of the invention, a conduit is run through said hole.

In accordance with an embodiment of the invention, the conduit is one or more cables.

In accordance with an embodiment of the invention, the conduit is one or more wires.

In accordance with an embodiment of the invention, the conduit is one or more pipes.

In accordance with an embodiment of the invention, one or more of the body and head are connected to the frame by one or more members.

In accordance with an embodiment of the invention, the members are moveable.

BRIEF DESCRIPTION OF THE SEVERAL VIEWS OF THE DRAWINGS

To easily identify the discussion of any particular element or act, the most significant digit or digits in a reference number refer to the figure number in which that element is first introduced.

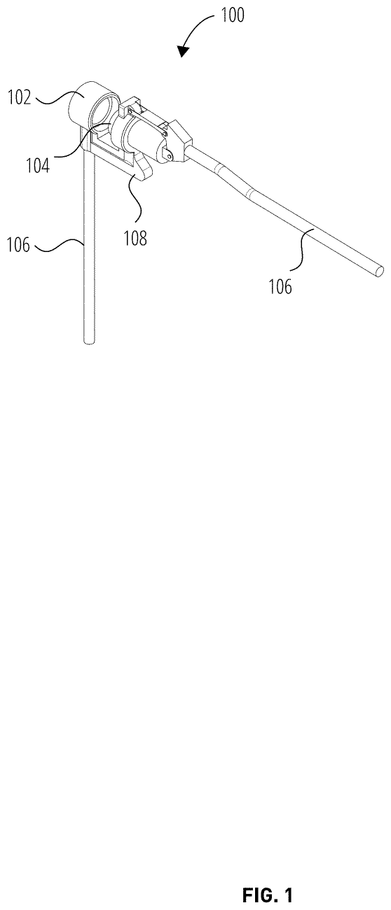

FIG. 1 illustrates an open position 100 in accordance with one embodiment.

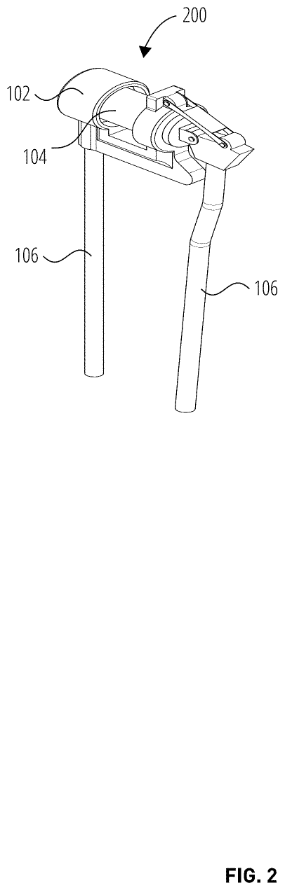

FIG. 2 illustrates a closed position 200 in accordance with one embodiment.

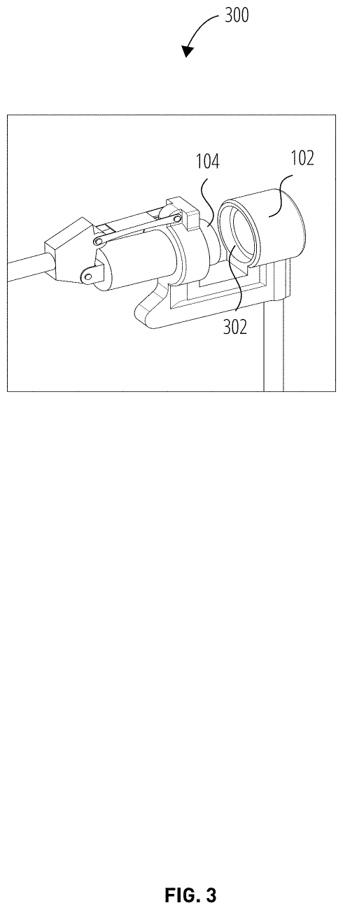

FIG. 3 illustrates a close up 300 in accordance with one embodiment.

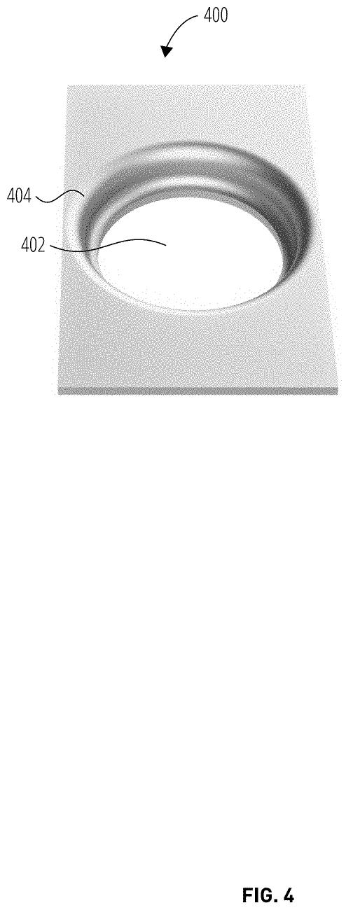

FIG. 4 illustrates a resulting hole 400 in accordance with one embodiment.

### DETAILED DESCRIPTION

The details of one or more embodiments of the subject matter of this specification are set forth in the accompanying drawings and the description below. Other features, aspects, and advantages of the subject matter will become apparent from the description, the drawings, and the claims.

Like reference numbers and designations in the various drawings indicate like elements.

Embodiments of the invention relate to a metal stud punch that functions to create a hole in a metal stud with a gradual smooth, concave opening. Prior to the cutting edge meeting the metal stud, a force is applied in a larger diameter to that of hole which forces the metal to bend around the punctured hole. Once the hole is punctured, the metal has a smooth, concave feature leading into the hole where various types of materials may be easily run through.

FIG. 1 depicts an open position 100 of a bevel stud punch as in one embodiment. The bevel stud punch is displayed with a frame comprising a body and head. The head consists of a first and second portions which are separated from each other by a space for receiving a preselected material to be punched. The first and second portions are operatively associated with a cylindrical head with an inner lip 102 and a punch 104 respectively. The cylindrical head with an inner lip 102 is coupled to a punch 104, where a preselected material may be placed in between prior to puncturing a hole. The cylindrical head with an inner lip 102 and the punch 104 are separated and the members are perpendicular to each other indicating the bevel stud punch is in its open position 100. The cylindrical head with an inner lip 102 and the punch are connected to a body 108 in plane such that the punch 104 may penetrate said cylindrical head with an inner lip 102. The body is employed to support the first and second portions of the head. In another embodiment, the cylindrical head with an inner lip 102 is attachable to an existing stud punch. In another embodiment, the cylindrical head with an inner lip 102 is fused to an existing stud punch. In another embodiment, one or more of the body and head are connected to the frame by one or more members.

FIG. 2 depicts a closed position 200 of a bevel stud punch as in one embodiment. A hole is punctured as a result of applying a force to the first and second portions of the bevel stud punch. In this example, a force has been applied to the align the members in parallel, which is transferred to drive the punch 104 to penetrate the cylindrical head with an inner lip 102. The applied force drives the punch 104 to puncture a hole through a preselected material, which is positioned in between the punch 104 and the cylindrical head with an inner lip 102.

FIG. 3 depicts a close up 300 of the cylindrical head with an inner lip 102 and punch 104 of one embodiment of a bevel stud punch. The smooth gradual shape of the cylindrical head with an inner lip 102 and its inner lip 302 are employed to form a concave rim around the outer edge of a preselected material leading to a punctured hole.

FIG. 4 depicts a resulting hole 400 in a sheet of metal of one embodiment of a bevel stud punch. Around the outer edge of a punctured hole 402 exists a deformation introduced by the cylindrical head with an inner lip 102. The deformation constitutes a concave rim 404 which leads into the hole 402 punctured by the punch 104. The concave rim 404 allows for ease of running a conduit such as, but not limited to, electrical and optical cables, wires and pipes through metal studs.

The foregoing descriptions of specific embodiments of the present invention have been presented for purposes of illustration and description. They are not intended to be exhaustive or to limit the invention and method of use to the precise forms disclosed. Obviously, many modifications and variations are possible in light of the above teaching. The embodiments described were chosen and described in order to best explain the principles of the invention and its practical application, and to thereby enable others skilled in the art to best utilize the invention and various embodiments with various modifications as are suited to the particular use contemplated. It is understood that various omissions or substitutions of equivalents are contemplated as circumstance may suggest or render expedient but is intended to cover the application or implementation without departing from the spirit or scope of the claims of the present invention.

what is claimed is:

1. A bevel stud punch attachment comprising:
a cylindrical head with an inner lip coupled to a punch to puncture a hole through a preselected material when a force is applied to drive said punch to penetrate said cylindrical head with said inner lip; and
said hole having a concave rim around an outer edge of said hole created by said inner lip.

2. The bevel stud punch attachment of claim 1, wherein said cylindrical head with said inner lip is attachable to an existing stud punch.

3. The bevel stud punch attachment of claim 1, wherein said cylindrical head with said inner lip is fused to an existing stud punch.

4. The bevel stud punch attachment of claim 1, wherein said preselected material is a metal stud.

5. A method of using the bevel stud punch attachment of claim 1, to puncture a hole with said concave rim, comprising:
positioning said preselected material between said cylindrical head with said inner lip and said punch; and
applying said force to drive said punch through said preselected material and into said cylindrical head with said inner lip.

6. The method of using the bevel stud punch attachment of claim 5, wherein a conduit is run through said hole.

7. The method of using the bevel stud punch attachment of claim 6, wherein said conduit is one or more cables.

8. A method of using the bevel stud punch attachment of claim 6, wherein said conduit is one or more wires.

9. A method of using the bevel stud punch attachment of claim 6, wherein said conduit is one or more pipes.

10. A bevel stud punch comprising:
a stud punch having a frame comprising a body and a head, said head having first and second portions being separated from each other by a space for receiving a preselected material to be punched;
a cylindrical head with an inner lip operatively associated with said first portion;
a punch operatively associated with said second portion; and
said body supporting said first portion and said second portion;
wherein a hole is punctured through said preselected material when a force is applied to said first or second portions, said hole having a concave rim around an outer edge of said hole created by said inner lip.

11. The bevel stud punch of claim 10, wherein one or more of said body and head are connected to said frame by one or more members.

12. The bevel stud punch of claim 11, wherein said members are moveable.
